(19) United States
(12) Patent Application Publication
(10) Pub. No.: US 2006/0202848 A1
(43) Pub. Date: Sep. 14, 2006

(54) Portable warning system for cooking appliances

(76) Inventor: David Volodarsky, Shavertown, PA (US)

Correspondence Address: LITMAN LAW OFFICES, LTD, PO BOX 15035, CRYSTAL CITY STATION, ARLINGTON, VA, 22215, US

(21) Appl. No.: 11/359,445

(22) Filed: Feb. 23, 2006

Related U.S. Application Data
(60) Provisional application No. 60/656,535, filed on Feb. 28, 2005.

(51) Int. Cl. G08B 21/00; G08B 1/08

(52) U.S. Cl. 340/654; 340/680; 340/539.1

(57) ABSTRACT

The portable warning system for cooking appliances includes a mechanism for detecting the state of the appliance through a current sensor for electric appliances or a sensor assembly operatively connected to an actuating member positioned adjacent to a range knob. The state detection mechanism emits a signal that indicates a change of state of the range from an “off” position to an “on” position and vice versa. A range transmitter unit is operatively connected to the detection mechanism and detects the signal from the detection mechanism. The range transmitter unit transmits a wireless communication to portable warning receiver units located throughout the building that the range is activated. The portable warning receiver units are configured to communicate different warning signals to an occupant when a range is on.

### CROSS-REFERENCE TO RELATED APPLICATION

This application claims the benefit of U.S. Provisional Patent Application Ser. No. 60/656,535, filed Feb. 28, 2005.

### BACKGROUND OF THE INVENTION

1. Field of the Invention

The present invention relates generally to fire prevention warning systems for appliances, and more particularly to a portable warning system for cooking appliances.

2. Description of the Related Art

Cooking appliances, such as gas and electric ranges and ovens, are used in many households to prepare food items. Statistics show that these appliances are the single largest cause of residential fires that occur each year. In the majority of cases, the fires result from the appliance and cooking food being left unattended.

A portable warning system that is easily retrofitted to any type of cooking appliance, that can reliably detect the state of the appliance, and that can provide effective warning to a person located at any place within a residence, can significantly reduce the risk of fires due to unattended operation. Other benefits of such a system include added peace of mind, the ability to provide a measure of protection and safety to the elderly and people with memory and attention disorders, and gas and electricity savings. Thus, a portable warning system for cooking appliances solving these problems is desired.

### SUMMARY OF THE INVENTION

The portable warning system for cooking appliances is designed and configured to integrate with any type of cooking appliance, including a gas or electrical range, oven, top stoves, etc. The warning system can also be used with cooking or heating appliances, such as toasters, electric irons, heaters, kettles, burners and other home electric appliances. The portable warning system provides a reliable mechanism for detecting the state of the cooking appliance and communicating this state to individuals located in any area within the residence in order to reduce the risk of unattended operation. The warning system uses multiple portable warning units to provide warning signals that notify a person when the range is turned on and that warn an individual when the individual is about to leave a protected area, possibly leaving the range unattended.

The warning signals communicated to the person include a periodic blinking light and audible beeper when the range is activated, an audible alarm and flashing light, which are activated when a person leaves a designated protected area, and a special light and audible sound that signals a predetermined condition has been obtained by the range, such as that the cooking time has expired and electricity is down.

The portable warning system also includes an alternative power source, for example a battery, which maintains the operation of the warning system when electricity is down. The warning units are intended to be located anywhere in the residence in order to provide extended coverage, for example, in the bedroom, living room, exit door or on an individual's person.

The portable warning system includes a sensor assembly, a range transmitter unit, and at least one portable warning receiver unit. The portable warning system can use either a current-based sensor when used with an electrical range or several types of switch-based sensor assemblies that connect mechanically, magnetically or electrically to the range knobs. The current sensor and all types of sensor assemblies are operatively connected to the range transmitter unit to indicate to the range transmitter unit whether the range is on or off. When using the current sensor, the range transmitter unit provides a delay mechanism to ensure reliable monitoring of electric ranges that periodically turn their burners on and off to maintain a target temperature.

The range transmitter unit monitors the state of the range as reported by the current sensor or a sensor assembly, and wirelessly transmits a signal indicating to the portable warning units that the range is on. The portable warning receiver units receive the signal from the range transmitter unit and provide a non-invasive audible and visual warning to indicate to the person that the range is on. The warning emitted by the receiver may be a medium length audible signal emitted at intervals of two to three minutes (or other programmable interval) so that the warning is not so annoying that a user may be tempted to deactivate the system entirely, yet is not so frequent that the user mentally adapts to the signal, thereby ignoring it. The portable warning units can be located in all areas of the house where the person may be located while the range is operational. The transmitter transmits the “appliance on” signal continuously, so that when the range is turned off, the receiver unit detects the loss of signal from the transmitter unit and stops emitting the warning.

The portable warning units can also provide protected area breach detection via a door sensor and generate an invasive audible and visual alarm to remind the person that the range is on before they leave the range unattended. This is usually intended for the exit door of the protected area. The portable warning receiver unit is designed to be mobile and may include a vibrator that signals to the person carrying the portable warning receiver unit that the range has been activated.

These and other features of the present invention will become readily apparent upon further review of the following specification and drawings.

### BRIEF DESCRIPTION OF THE DRAWINGS

FIG. 1 is block diagram of a portable warning system for cooking appliances according to the present invention.

FIG. 2 is a block diagram showing an electric plug extender with current sensor of a portable warning system for cooking appliances according the present invention.

FIG. 3 is a block diagram of a portable warning system for cooking appliances according to the present invention showing further detail of the sensor assembly.

FIG. 4 is a block diagram of a portable warning system for cooking appliances according to the present invention showing further detail of an optoelectronic switch assembly.

FIG. 5 is a detail view showing a sensor assembly of the portable warning system connected to a gas range according to the present invention.

FIG. 6 is a block diagram of an electronic oven sensor in communication with a range transmitter unit of the portable warning system according to the present invention.

FIG. 7 is a schematic diagram of a relay range sensor of the portable warning system according to the present invention.

FIG. 8 is a schematic view of the range transmitter unit of the portable warning safety system according to the present invention.

FIG. 9 is a detailed view showing a warning receiver unit of the portable warning system employed adjacent to a door according to present invention.

Similar reference characters denote corresponding features consistently throughout the attached drawings.

### DETAILED DESCRIPTION OF THE PREFERRED EMBODIMENTS

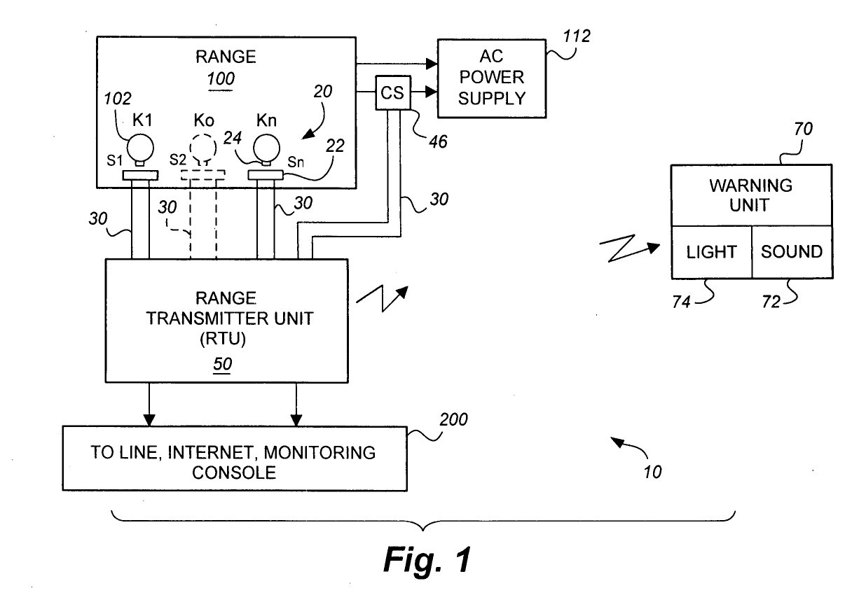

Referring to FIG. 1, a portable warning system, generally indicated at 10, is shown according to the present invention. The portable warning system 10 is configured and adaptable to be operatively connected to or integrated with any type of cooking appliance 100, such as a gas or electric range. The portable warning system 10 is connected to a primary AC power source, and is configured to automatically switch to an auxiliary power source, such as a battery, when the primary power source becomes inoperative. The portable warning system 10 includes a switch or sensor assembly 20 disposed between the range 100 and the range transmitter unit 50. The sensor assembly 20 is configured to indicate the state of the range 100 to the range transmitter unit 50, producing a signal when the range 100 is on. The sensor assembly 20 may be used with any type of range.

A current sensor 46 is configured to detect the state of the range 100 for electric ranges only, and to indicate that state to the range transmitter unit 50. The sensor assembly 20 and the current sensor 46 are configured to communicate with the range transmitter unit 50 in order to activate the range transmitter unit 50 when the range 100 is activated (at least one burner or heating element is on) and to deactivate the range transmitter unit 50 when the range 100 is off. The communication between the range transmitter unit 50 and the sensor assembly 20 can be wireless. The range transmitter unit 50 can be located at any convenient place adjacent to the range 100, or can be adapted to be built-in as part of the range 100.

The range transmitter unit 50 is in wireless communication with at least one portable warning receiver unit 70. The range transmitter unit 50 is configured to monitor the state of the range 100 so that when the range 100 is turned on, a wireless signal is transmitted from the range transmitter unit 50 to the portable warning receiver unit 70. The wireless signal triggers or activates the portable warning receiver unit 70 into an active mode, which results in a warning signal being communicated therefrom that the range 100 is on.

The range transmitter unit 50 can be connected to a monitoring console 200 by any suitable communication means, for example, a phone, cable, Internet, radio frequency, or wires. Moreover, a plurality of range transmitter units 50 can be employed for use with multiple ranges 100 with all of the range transmitter units 50 being connected to a single monitoring console 200, or to multiple monitoring consoles 200, such as, for example, when employed in an apartment complex, assisted living facility, or a restaurant having more than one range 100.

The portable warning receiver unit 70 is adapted and configured to be portable, mobile, and adaptable for operation in multiple locations within a house or building, such as the kitchen, bedroom, living room, dining room, bathroom, basement, attic, and office, or the receiver unit 70 may be carried by a person. There can be a plurality of warning receiver units 70 in the building to provide warning coverage to multiple areas of the house. The units 70 can be easily added or removed at any time. The portable warning receiver unit 70 is in wireless communication with the range transmitter unit 50 for receiving a signal, but hardwired communication is an acceptable alternative. The receiver unit 70 receives information from the range transmitter unit 50 and communicates a signal to a person based on that information, such as a beeping sound and blinking lights, that notifies the person that the range 100 is on.

The portable warning receiver unit 70 includes at least one illuminating mechanism 74 and sound and/or vibration mechanism 72, which transmit and communicate various audible, vibrational, and visual signals to a person or occupant. The illuminating mechanism 74 employed can be a light, such as a light bulb, light emitting diode, or other suitable lighting means. The sound mechanism 72 used can produce an audible alarm and beeping noise and can include a vibration mechanism for vibrating the portable warning receiver unit 70 when being carried by a person.

The portable warning receiver unit 70 utilizes multiple signals, modes, and/or levels for communicating different information to a person. For example, the portable warning receiver unit 70 may have at least one and preferably four warning levels. The first level of warning is to generate short, periodic audible and visual signals to remind the person that the range is on. The period of the warning alarm is selected to prevent the warning from being too invasive and, also, to prevent the user from becoming used to the warning signal and ignoring it. The warning signal may be user adjustable (e.g., the length of the period between warning signals), and may be capable of varying audio and visual characteristics during operation in an attempt to avoid sensory adaptation. The second level of warning is to signal an alarm when a person attempts to leave a protected zone or area, the third level of warning is to signal when a preset working time of a range 100 has expired, and the fourth level of warning is to signal when the electrical power is below normal operating parameters.

The portable warning receiver unit 70 can also support the communication of other information, such as cooking time, range operating time, low battery or power, electrical outage, electrical power consumption, and breach of a protected area or zone. For example, when a person leaves the protected area, the portable warning receiver unit 70 is activated from non-invasive mode to invasive mode and signals to the person that the range 100 is on. The signal is preferably an alarm and/or flashing lights.

Different audible and visual signals from the portable warning receiver unit 70 are used to communicate a variety of information to a person or computer program monitoring the portable warning system 10, or to an occupant of the house, about the status or state of the range 100. For example, as the range 100 is activated or turned on, the range transmitter unit 50 detects a change of state in the sensor assembly 20, which triggers the range transmitter unit 50 into an active mode and/or state for transmitting a signal to the portable warning receiver unit 70 that the range 100 is now activated. The wireless signal received by the portable warning receiver unit 70 triggers the portable warning receiver unit 70 into an active mode, such as a non-invasive mode, in which the portable warning receiver unit 70 communicates a warning signal to the person that the range 100 is activated. The warning signal will typically be a blinking light and/or periodic sound, such as a short beeping noise or a short vibration. The range transmitter unit 50 transmits a signal to the receiving unit 70 continuously while the range 100 is on, so that when the range 100 is deactivated, the sensor assembly 20 returns to its original state, which causes the range transmitter unit 50 to stop sending a signal to the portable warning receiver unit 70. The receiver unit 70 interprets the loss of signal from the transmitter unit 50 as an indication that the range 100 has been shut off, so that the receiver unit 70 deactivates the warning signal.

The portable warning system 10 supports several mechanisms, including the sensor assembly 20 and the current sensor 46, for detecting the state of the cooking appliance to which the mechanism is connected. Only one mechanism is used at any given time for any given appliance to detect its state, depending on the appliance and the preferred implementation. The current sensor 46 determines the state of an electric range by monitoring the power consumption of the appliance and can be built into it. The sensor assembly 20 may determine the state of either a gas or electric range.

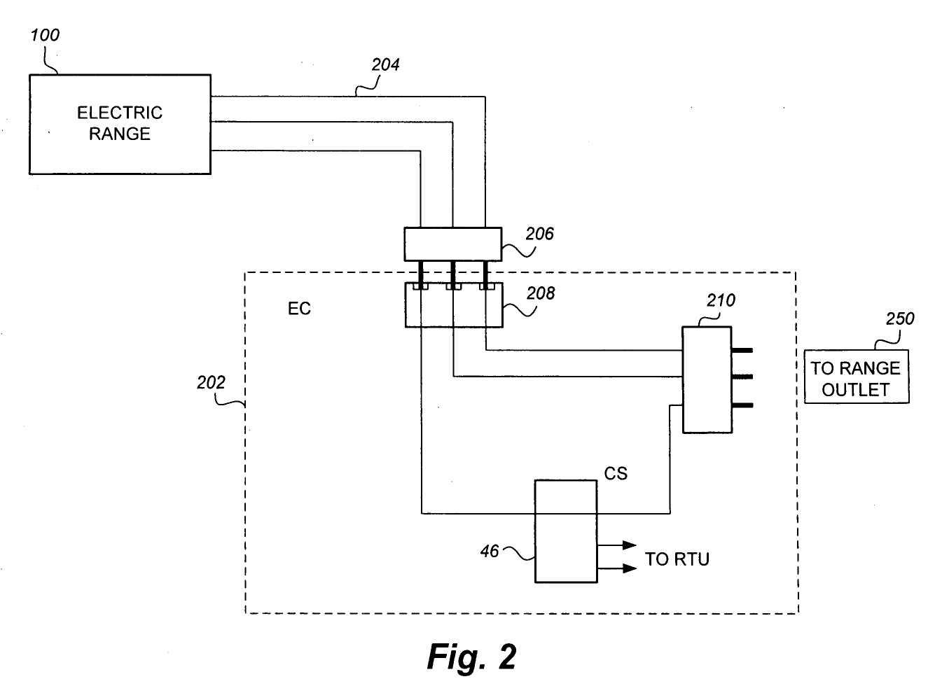

Turning now to FIG. 2, an electric plug extender 202 is shown connecting an electric range 100 to a range outlet 250. The current sensor 46 is built into the electric plug extender 202. Conductors 204 run from the range 100 to a range plug 206, which is plugged into the electric plug extender 202. The range plug 206 connects to a power jack 208 of the electric plug extender 202. The current sensor 46 is installed on one of the power conductors 204 running between the power jack 208 and an outlet plug 210 and detects whether a burner on the electrical range 100 is on. The current sensor 46 also connects to the range transmitter unit 50 to provide the information about the power state of the range 100. The outlet plug 210 is designed to plug into the range outlet 250, ultimately allowing for an electrical connection between the electric range 100 and the electric range outlet 250. The electric plug extender 202 allows connecting an electric range 100 via a current sensor 46 to the range transmitter unit 50 and can be used with existing electric ranges without any changes in their designs. A similar plug extender 202 can be used for connecting toasters, electric irons, kettles, burners, heaters and other home appliances to the range transmitter unit 50 and may also be a 4-wires device.

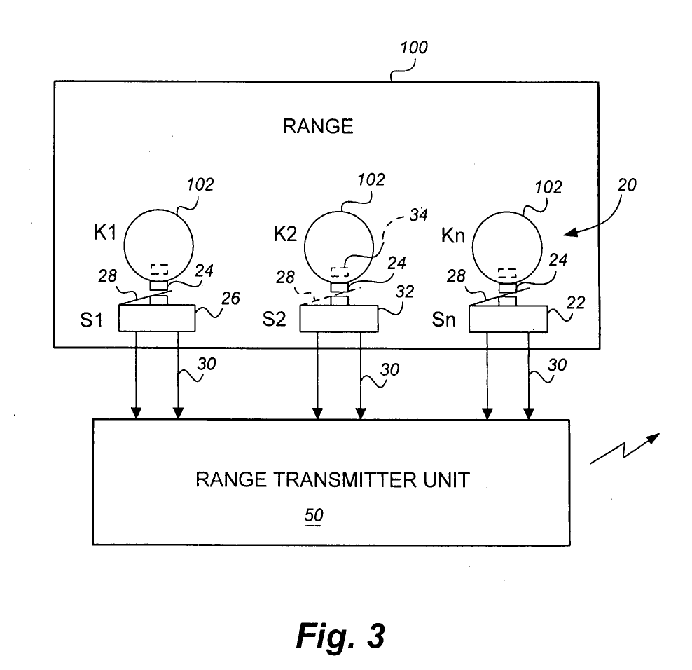

As illustrated in FIG. 3, the sensor assembly 20 is adapted to transmit a signal to the range transmitter unit 50 when the range 100 is activated and deactivated. The sensor assembly 20 includes a plurality of sensors or switches (S1, S2, . . . , SN) 22, which are configured and arranged to connect to a plurality of range knobs (K1, K2, . . . , Kn) 102. Activation of the switches 22 does not depend on an angle of turning the range knobs. The switches 22 change their states as soon as the knobs move from the off position. The switches 22 are in communication with the range transmitter unit 50 to activate the range transmitter unit 50 when a range knob 102 is turned or moved. The sensor assembly 20 is configured to connect to the range knob 102 by any suitable connection means, including mechanically, electrically, magnetically, optically, or the assembly 20 can be integrated as part of the range knob 102. The switch 22 is preferably connected to the range transmitter unit 50 by an electrical contact or connection, such as electrical wires 30, and is positioned adjacent to the range knob 102. Alternatively, the range transmitter unit 50 can be in wireless communication with the sensor assembly 20.

The sensor assembly 20 includes at least one actuating member 24, which is connected to the range knob 102. The actuating member 24 is generally positioned on the range knob 102 to selectively close or open the contacts of the switch 22 when the range knob 102 is in the “off” position, and to open or close the contacts of the switch 22 when the range knob 102 is in an “on” position. For example, as the range knob 102 is turned on, the actuating member 24 opens the contacts of the switch 22. This results in an open circuit that is detected by the range transmitter unit 50, which results in a wireless signal being transmitted from the range transmitter unit 50 to the portable warning receiver unit 70. This wireless signal activates the portable warning receiver unit 70 and results in a warning signal being communicated to the occupant that the range 100 is on.

It will be appreciated that different types of switches 22 and actuating members 24 can be utilized for detecting when the range is turned on/off. As a result, the switch 22 can be a magnetic reed switch, a button switch, an optoelectronic switch or any other suitable electrical or mechanical switch. For example, when the switch 22 is a magnetic reed switch 32, the actuating member 24 includes a magnet member 34 positioned on the range knob 102 so that the contacts of the magnetic reed switch 32 are closed when the range knob 102 is in the “off” position. When the range knob 102 is turned on, the contacts of the magnetic reed switch 32 open, creating a change of state that is detected by the range transmitter unit 50.

In a similar manner, when the switch 22 is a button switch 26, the actuating member 24 engages a trigger arm, plate, or lever 28, which extends from the button switch 26. The trigger arm 28 closes the contacts of the button switch 26 when the range knob 102 is in the “off” position and opens the contacts when the range knob 102 is in the “on” position. The range transmitter unit 50 detects the change of state from an original signal to a different signal when the button switch 26 is opened. This change of state results in the range transmitter unit 50 transmitting a wireless signal to the portable warning receiver unit 70 that the range 100 is on, which, in turn, results in a beeping noise or vibration being communicated from the portable warning receiver unit 70.

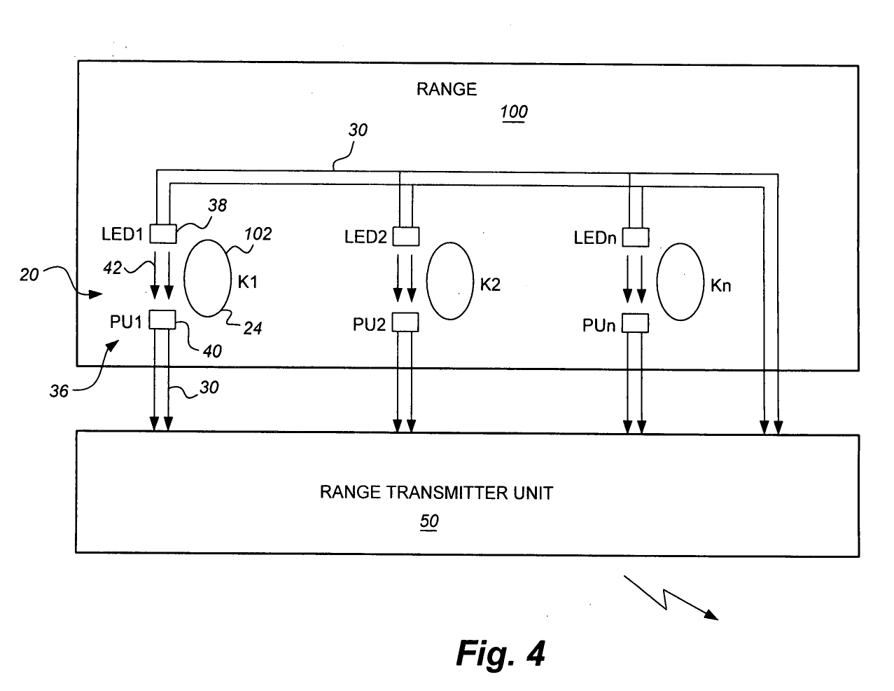

As shown in FIG. 4, the switch 22 can be an optoelectronic switch 36. The optoelectronic switch 36 includes at least one light emitting diode (LED) 38, photo unit (PU) 40, and light beam 42, which is in communication between the light emitting diode 38 and the photo unit 40. The actuating member 24 is positioned adjacent to, or connected to, the range knob 102, so that when the range knob 102 is turned on, the actuating member 24 obstructs or interferes with the light beam 42, which results in an open circuit that activates the range transmitter unit 50, and which results in the range transmitter unit 50 communicating a wireless signal to the portable warning receiver unit 70 that the range 100 is activated or “on”. Preferably, the actuating member 24 defines a range knob 102 that has a generally elliptical, oval, rectangular, oblong, square, or semi-circular shape. It will be appreciated that different types of optoelectronic switches and photo units may be employed, such as a photodiode, a photothyristor, a photo resistor, or a phototransistor.

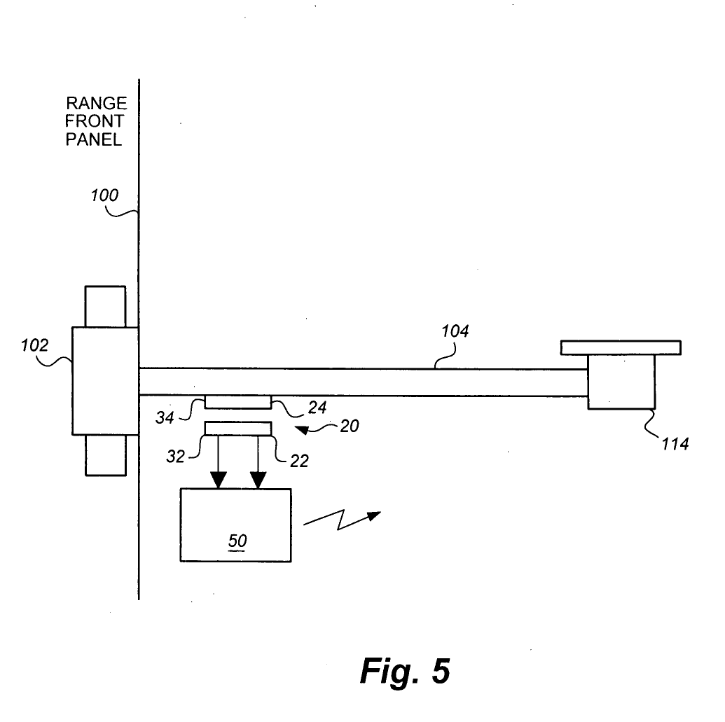

Referring to FIG. 5, the sensor assembly 20 can be a magnetic reed switch, a button switch, an optoelectronic switch, or any other suitable electrical switch, as described above. The switch 22, such as magnetic reed switch 32, is electrically connected to the range transmitter unit 50 by electrical wires. The magnetic reed switch 32 is positioned adjacent to the shaft 104 of the range knob 102. The actuating member 24, such as a magnet 34, is connected to the shaft 104. The magnet 34 is generally positioned on the shaft 104 of the range knob 102 to selectively close or open the contacts of the magnetic reed switch 32 when the range knob 102 is in the “off” position and to open or close the contacts of the magnetic reed switch 32 when the range knob 102 is in an “on” position.

By way of example, when the shaft 104 of the range knob 102 is rotated to turn the gas or electric range burner 114 on, the magnetic member 34 opens the contacts of the magnetic reed switch 32, which creates an open circuit that is detected by and activates the range transmitter unit 50, and which results in a signal being transmitted to the portable warning receiver unit 70. The portable warning receiver unit 70 is activated to send a warning signal to the occupant that the range 100 is on.

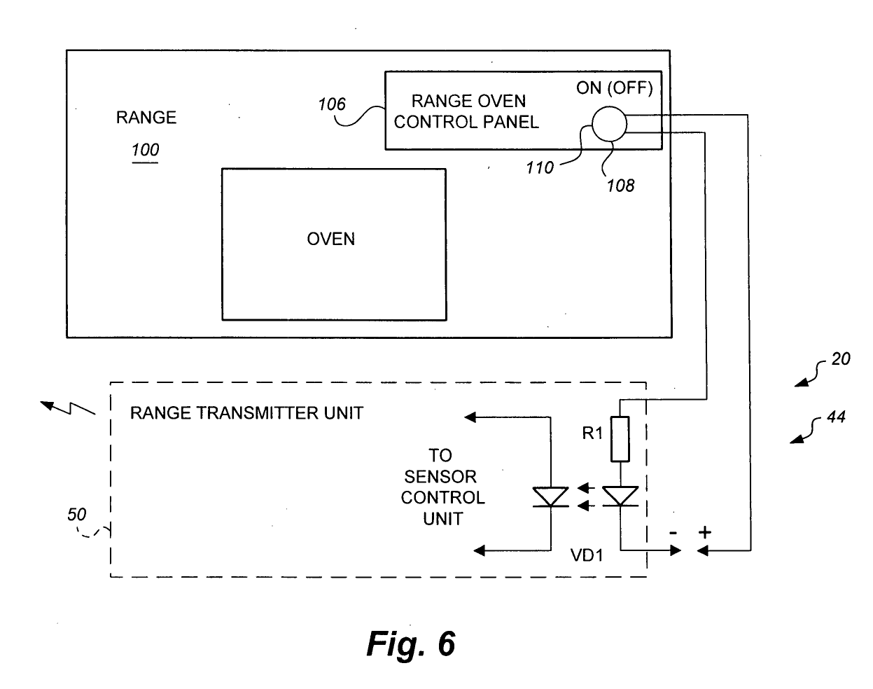

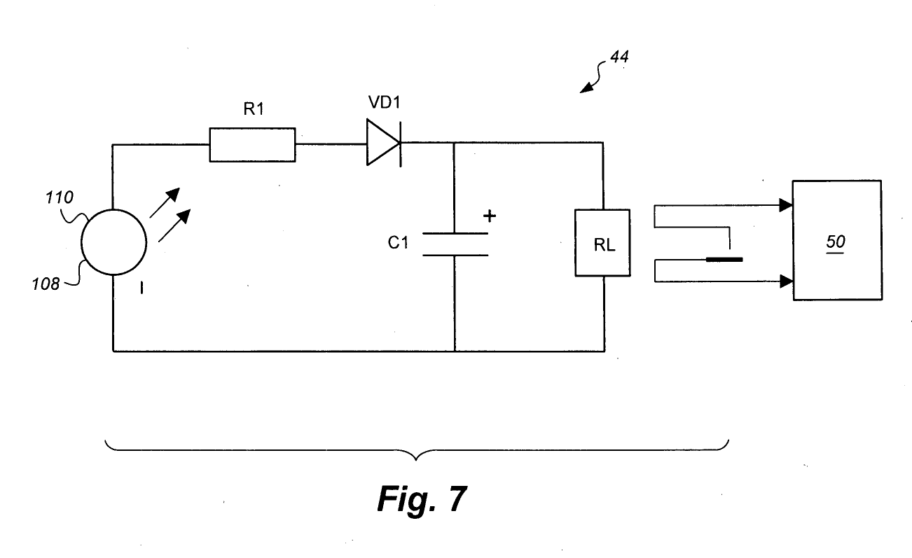

As shown in FIGS. 6 and 7, the sensor assembly 20 may be implemented as an electronic sensor 44 for detecting changes of state of an oven in the range 100 and range itself, respectively. The electronic sensor 44 is generally connected to a range oven control panel 106. The sensor 44 may be connected to an on/off button 110 located on the control panel 106, or may be connected to an indicator light 108 on the control panel 106 that communicates to the operator that a burner or the oven is on or off. The sensor assembly 20, such as a relay or an optoelectronic switch, is connected to the on/off button 110 or to the indicator 108, and is in communication with the range transmitter unit 50. When the oven's on/off button 110 is depressed, the electronic sensor 44 signals a change of state in the circuit of the range 100, which is detected by the range transmitter unit 50 and results in a signal being transmitted by wireless communication to the warning receiver units 70. The warning receiver units 70 then communicate a warning signal to the person that the range 100 is on, as described above. Typically, the resistor (R1), relay (RL), diode (VD1), and/or capacitor (C1) are configured to indicate or detect changes in the electrical state of the range 100. It is preferable to have all types of switches include a current sensor built into the design of a cooking appliance, although the design of the current sensor and knob sensor assembly is intended to integrate with existing appliances without appliance modification.

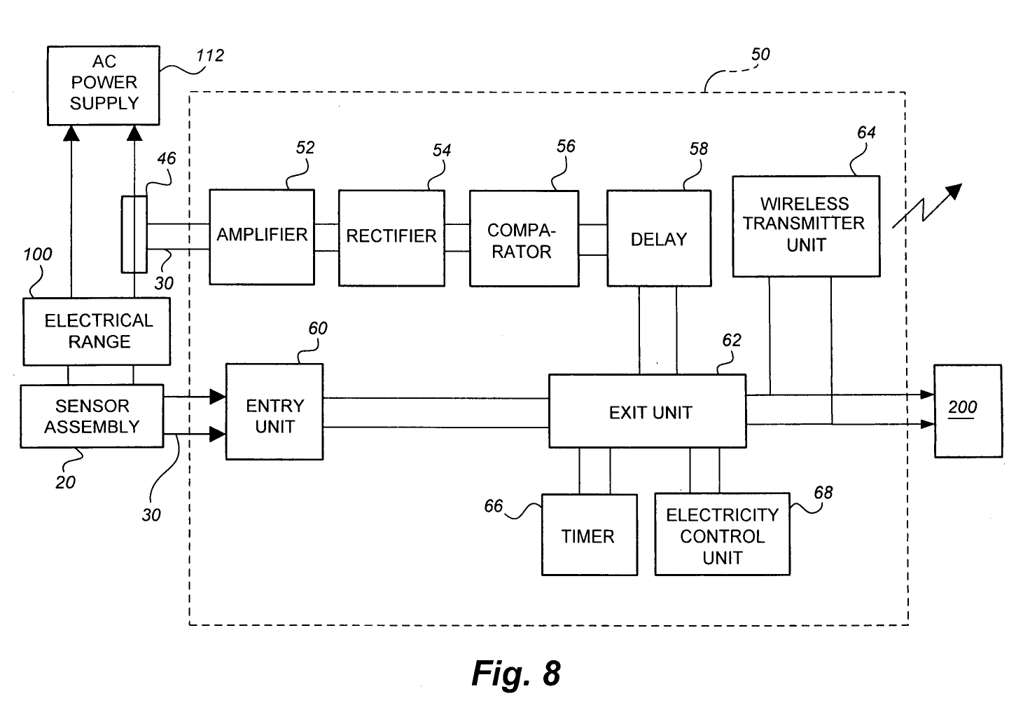

As illustrated in FIG. 8, the range transmitter unit 50 includes the amplifier 52 that receives an AC signal from the current sensor 46 and either steps up or steps down the AC signal being fed by the current sensor 46. The amplified AC signal is then fed into the rectifier 54, where the AC signal is converted into a DC signal. The range transmitter unit 50, to which the current sensor 46 connects, also includes a comparator 56, such as a transistor, integrated circuit, or processor, that receives the DC signal and performs a logic step or operation. A control signal is then transmitted through the delay mechanism 58 to the exit unit 62. The comparator 56 prevents false positives due to a resting state level of power consumption by the range 100 when the range 100 is off, e.g., power consumption due to light indicators or a clock.

The current sensor 46 is positioned between the AC power supply 112 and the range 100. The current sensor 46 can be added in the existing range design by placing the current sensor 46 on one of the power range lines going to the range 100 from the power outlet (supply line) or can be built into the range 100. The current sensor 46 can also be configured to connect to the electrical range plug and is adapted to plug into the electrical range outlet. No changes in the design of existing electrical ranges are needed in this case. Toasters, electric kettles, burners, heaters and other home electric appliances can be connected to the range transmitter unit 50 in the same way. The current sensor 46 is connected to the range transmitter unit 50 and sends a signal that is detected by the range transmitter unit 50. When the range 100 is turned on, the signal from the current sensor 46 changes, which indicates a change of state with the range 100. The range transmitter unit 50 is configured to determine the appropriate signal to send to the portable warning unit 70 based on electrical changes of state of the range 100.

The delay mechanism 58 is incorporated into the range transmitter unit 50 to compensate for the periodic changes in power consumption during the operation of the range 100. For example, due to heating elements, such as electrical burners, being operated by infinite switches, when a particular heating element of the range 100 has reached the predetermined operating temperature, the power being supplied to that heating element is temporarily turned off by infinite switches until the heating element falls below the predetermined operating temperature. The power is then turned on to bring the heating element to its operating temperature. There is no power consumption, and therefore no signal generated by the current sensor, when a range 100 is temporarily turned off by infinite switches. These periodic on/off operations generate a short change in power consumption, which usually lasts less than one minute. This behavior can result in the failure of the warning system 10 to properly indicate the state of the range 100, because there are no warning signals when a range 100 is temporarily turned off by infinite switches, and may result in the person leaving a protected area with a range 100 left on. Thus, the delay mechanism 58 allows for greater reliability because without the delay mechanism 58, the system 10 would report that the range 100 is turned off when the burners are only temporarily off.

Typically, the range 100 will repeat the on/off operation a number of times during the operation of the heating element. The delay mechanism 58 is configured to remember the electrical state of the range 100 for a preset period of time, which is generally longer than the on/off operation of the heating element of the range 100. Hence, the delay mechanism 58 compensates for these on/off fluctuations in order to maintain the range transmitter unit 50 in an active state during the normal operation of the range 100. Therefore, the portable warning system 10 may report the electrical range 100 as active after the range 100 has been turned off for an additional time equal to the delay timeout, which is acceptable because the delay timeout is relatively short. No warning signals can be manually reset, excluding a timer signal, until a range 100 is off.

Based on the multiple control signals received by the comparator 56, the exit unit 62 will send a corresponding signal to the wireless transmitter unit 64, where the signal is converted into a wireless signal for transmitting to the warning receiver unit 70. Comparator 56 can determine whether the power consumption of range 100 is above a minimal level. This is needed for ranges that include electronic components, such as LCD displays, lights, or timers, which have low power consumptions that should not trigger the system, as opposed to the electric burners or heating filaments themselves, which generate current above the minimal level to trigger the system. A cooking timer 66 can optionally be provided to generate a special signal to the exit unit 62 when a preset time for operating the range 100 has expired. The electricity control unit 68 is configured to send multiple signals to the exit unit 62 when the home electricity supply is inoperative or below normal operating parameters. The electricity control unit 68 also switches the range transmitter unit 50 automatically to power back up, such as a battery, when home electricity is down. The entry unit 60 is configured to receive different signals from the sensor assembly 20 and communicates those signals to the exit unit 62, where the exit unit 62 sends the appropriate signal to the wireless transmitting unit 64 and the monitoring console 200. Alternatively, exit unit 62 can communicate with warning receiver unit 70 through a hardwired connection. The range transmitter unit 50 can be used to obtain signals from sensor assembly (gas or electric ranges) and home electric appliances (toasters, burners, heaters, etc.) at the same time.

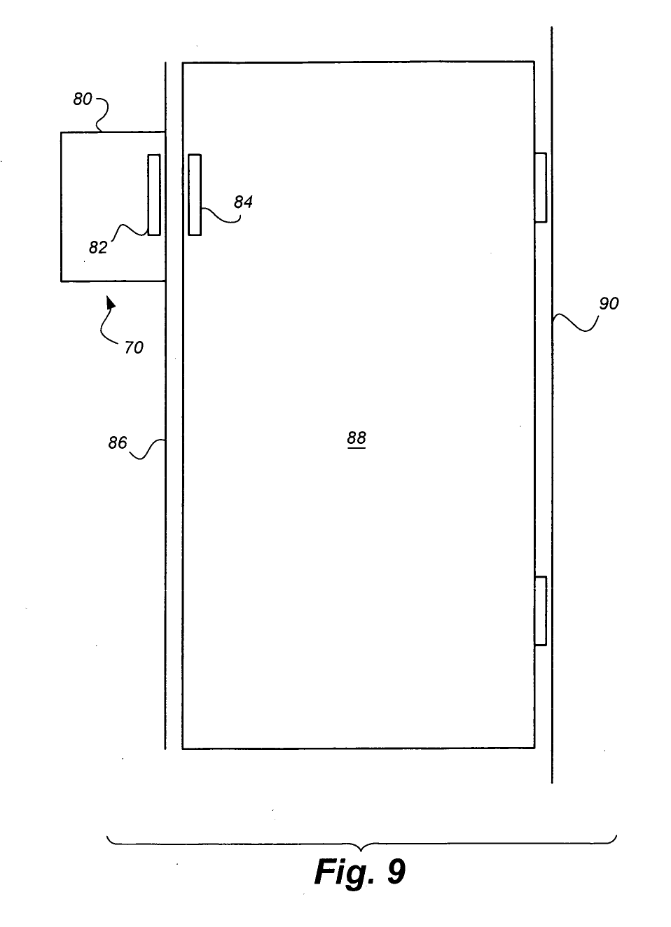

As shown in FIG. 9, the portable warning receiver unit 70 is adaptable to be mounted or attached to a wall 86, door frame 90, or door 88 for providing a protected zone or area. The protected area can be anywhere within the building, such as an exit door, a bedroom door, a kitchen door, a bathroom door, a living room or dining room door, or an office door. In this arrangement, the portable warning receiver unit 70 provides a mechanism to detect the breach of a protected area, such as a door-opening sensor, and provides an invasive alarm mode when the breach is detected.

The switch assembly 80 can be any type of switch assembly, such as a magnetic reed switch, a button switch, or a motion detector. Preferably, the switch assembly 80 defines a magnetic reed switch 82 mounted adjacent to the door 88, so that the actuating member 84, in the form of a magnetic member 84 attached to the door 88, activates the sound warning signal of the warning receiver unit 80 as the door is opened by a person. The warning signal is generally in the form of an audible sound, such as an alarm or beeper, which communicates to the person leaving the room that the range 100 is activated or on.

The warning receiver unit 80 is in wireless communication with the range transmitter unit 50 and can be located anywhere within a building or house. The magnetic reed switch 82 can be incorporated as part of the warning receiver unit 80.

In operation, the range transmitter unit 50 detects an electrical change of state of the range 100 from the sensor assembly 20 or current sensor 46 and transmits a wireless signal to the portable warning receiver unit 70, and upon receipt of the wireless signal the portable warning receiver unit 70 emits or communicates an audible alarm and flashing lights to notify a person that the range 100 is on. Additional functions may be provided on top of the portable warning system 10, such as the cooking timer, range on time, and remote monitoring of the cooking appliance via a monitoring console, phone line, security system, or the Internet.

The various mechanisms for appliance state detection, including the various switch assemblies and the current sensor delay mechanism, may be used to provide appliance state detection for an existing, outside monitoring system that provides its own signal transmission and warning infrastructure and does not use the range transmitter unit and warning unit components, such as a home security system. The mobile warning units may be used with an alternative mechanism of appliance state detection, such as mechanisms integrated into the appliance by the appliance manufacturer in order to provide warning and alarm functionality for the appliance.

While communication between the range transmitter unit 50 and warning receiver units 70 is described as wireless, untethered communication is not mandatory and the range transmitter unit and warning units may be electrically connected to one another.

It is to be understood that the present invention is not limited to the embodiments described above, but encompasses any and all embodiments within the scope of the following claims.

I claim:

1. A portable warning system for an appliance used to heat and cook foods, the system comprising:
a detection mechanism adapted for attachment to the appliance having circuitry for detecting and signaling a change of state of the appliance between an “off” position and an “on” position;
a transmitter unit connected to the detection mechanism, the transmitter unit having circuitry for detecting the change of state signal and transmitting a signal; and
at least one portable warning receiver unit in wireless communication with the transmitter unit, the portable warning receiver unit having circuitry for receiving the signal from the transmitter unit and communicating a warning signal when the appliance is in an “on” position;
wherein the transmitter unit detects the electrical change of state signal of the appliance from the detection mechanism and transmits a wireless signal to the portable warning receiver unit, and upon receipt of the wireless signal the portable warning receiver unit emits a periodic warning during operation of the appliance.

2. The portable warning system according to claim 1, further comprising a monitoring console, the monitoring console being in communication with the range transmitter unit for remote monitoring of the appliance.

3. The portable warning system according to claim 1, wherein the detection mechanism is a current sensor adapted for being connected to a power supply conductor of the appliance.

4. The portable warning system according to claim 3, further comprising an electric plug extender having a power jack adapted for receiving a power plug of the appliance and an outlet plug adapted for connecting to an electrical outlet, the current sensor being connected between the power jack and the outlet plug.

5. The portable warning system according to claim 3, wherein the transmitter unit comprises:
an amplifier having circuitry for receiving an AC signal from the current sensor;
a rectifier electrically connected to the amplifier for receiving the amplified AC signal from the amplifier and converting the AC signal to a DC signal;
a comparator electrically connected to the rectifier and producing a control signal;
a delay mechanism electrically connected to the comparator for receiving the control signal;
an exit unit for receiving the control signal from the delay mechanism; and
a wireless transmitter unit for receiving the control signal from the exit unit and converting the control signal into a wireless signal for transmission to the portable warning receiver unit.

6. The portable warning system according to claim 1, wherein the detection mechanism comprises a sensor assembly adapted for connection to at least one knob of the appliance.

7. The portable warning system according to claim 6, wherein the sensor assembly comprises;
a switch electrically connected to said transmitter unit; and
an actuating member connected to the switch and adapted for being coupled to the at least one knob of the appliance, the actuating member being configured to open the switch when the at least one knob of the appliance is in an “on” position and configured to close the switch when the at least one knob of the appliance is in an “off” position.

8. The portable warning system according to claim 7, wherein the switch comprises a magnetic reed switch.

9. The portable warning system according to claim 7, wherein the switch comprises a button switch.

10. The portable warning system according to claim 7, wherein the switch comprises an optoelectronic switch.

11. The portable warning system according to claim 1, wherein the at least one portable warning receiver unit further comprises a door-opening sensor for detecting when a door to an area protected by the portable warning receiver unit is opened and emitting an alarm when motion is detected beyond the prescribed area and the appliance is in the “on” position.

12. The portable warning system according to claim 1, wherein the warning signal emitted from the portable warning receiver unit comprises an audible warning, the receiver having a circuit for emitting audio.

13. The portable warning system according to claim 1, wherein the warning signal emitted from the portable warning receiver unit comprises an optical warning, the receiver unit having a circuit for emitting an optical signal.

14. The portable warning system according to claim 1, wherein said receiver unit further comprises means for determining when an occupant leaves an area protected by the system with the appliance in the “on” position and immediately emitting an alarm signal.

15. A portable warning system for an appliance for heating and cooking food, the system comprising:
a detection mechanism adapted for attachment to the appliance, the detection mechanism having a circuit for detecting and signaling a change of state of the appliance between an “off” position and an “on” position;
a transmitter unit connected to the detection mechanism, the transmitter unit having a circuit for detecting the change of state signal and transmitting a signal;
at least one portable warning receiver unit in communication with the range transmitter unit, the portable warning receiver unit having a circuit for receiving the signal from the transmitter unit and communicating a warning signal when the appliance is in an “on” position; and
a monitoring console in communication with the transmitter unit for remote monitoring of the cooking appliance;
wherein the transmitter unit detects the electrical change of state signal of the appliance from the detection mechanism and transmits a wireless signal to the portable warning receiver unit, and upon receipt of the wireless signal the portable warning receiver unit emits a periodic warning during operation of the appliance.

16. The portable warning system according to claim 15, wherein the detection mechanism is a current sensor adapted for being connected to a power supply conductor of the appliance.

17. The portable warning system according to claim 16, further comprising an electric plug extender having a power jack adapted for receiving a power plug of the appliance and an outlet plug adapted for connecting to an electrical outlet, the current sensor being connected between the power jack and the outlet plug.

18. The portable warning system according to claim 15, wherein the transmitter unit comprises:
an amplifier having circuitry for receiving an AC signal from the current sensor;
a rectifier electrically connected to the amplifier for receiving the amplified AC signal from the amplifier and converting the AC signal to a DC signal;
a comparator electrically connected to the rectifier and producing a control signal;
a delay mechanism electrically connected to the comparator for receiving the control signal;
an exit unit for receiving the control signal from the delay mechanism; and
a wireless transmitter unit for receiving the control signal from the exit unit and converting the control signal into a wireless signal for transmission to the portable warning receiver unit.

19. The portable warning system according to claim 15, wherein the detection mechanism comprises a sensor assembly adapted for connection to at least one knob of the appliance.

20. The portable warning system according to claim 19, wherein the sensor assembly comprises;
a switch electrically connected to said transmitter unit; and
an actuating member connected to the switch and adapted for being coupled to the at least one knob of the appliance, the actuating member being configured to open the switch when the at least one knob of the appliance is in an “on” position and configured to close the switch when the at least one knob of the appliance is in an “off” position.
